(19) United States
(12) Patent Application Publication
(10) Pub. No.: US 2007/0263584 A1
(43) Pub. Date: Nov. 15, 2007

(54) Method and apparatus for transmitting/receiving uncompressed audio/video data

(75) Inventor: Ki-bo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/714,123

(22) Filed: Mar. 6, 2007

Related U.S. Application Data
(60) Provisional application No. 60/798,746, filed on May 9, 2006.

(30) Foreign Application Priority Data
Sep. 4, 2006 (KR) 10-2006-0084875

(51) Int. Cl. H04B 7/216

(52) U.S. Cl. 370/342

(57) ABSTRACT

Provided is a radio communication technique, more particularly, a method and apparatus for formatting a transmission packet according to significance of data. A method of transmitting uncompressed AV data includes receiving bits constituting the uncompressed AV data; separating the received bits into a plurality of bit levels according to significance; multiplexing the separated bits according to the bit levels; and transmitting the multiplexed bits.

### CROSS REFERENCE TO RELATED APPLICATION

This application claims priority from Korean Patent Application No. 10-2006-0084875 filed on Sep. 4, 2006, in the Korean Intellectual Property Office, and U.S. Provisional Patent Application No. 60/798,746 filed on May 9, 2006 in the United States Patent and Trademark Office, the disclosures of which are incorporated herein by reference in their entirety.

### BACKGROUND OF THE INVENTION

1. Field of the Invention

Apparatuses and methods consistent with the present invention relate to a radio communication technique, and more particularly, to formatting a transmission packet according to significance of data.

2. Description of the Related Art

With the advancements made in wireless network techniques, the demand for transmission of mass multimedia data has been increasing, along with the demand for an effective transmission method in a wireless network environment. In addition, the necessity for wireless transmission of a high-quality video, such as a Digital Video Disk (DVD) video, and high definition television (HDTV) video, among various home devices is also increasing.

Currently, a task group of IEEE 802.15.3c is considering a technical standard for transmitting mass data over a wireless home network. This standard, called “mmWave” (millimeter wave), uses an electrical wave having a physical wavelength of several millimeters to transmit mass data (i.e., an electrical wave having a frequency of 30 GHz to 300 GHz). In the related art, this frequency band is an unlicensed band and is limitedly used for example, in communication carriers, radio astronomy, or vehicle anti-collision.

FIG. 1 is a diagram illustrating a comparison between the frequency band of the IEEE 802.11 standard and the frequency band of the mmWave. In the IEEE 802.11b standard or the IEEE 802.11g standard, a carrier frequency is 2.4 GHz, and a channel bandwidth is about 20 MHz. Further, in the IEEE 802.11a standard or the IEEE 802.11n standard, a carrier frequency is 5 GHz, and a channel bandwidth is about 20 MHz. In contrast, in the mmWave, a carrier frequency of 60 GHz is used, and a channel bandwidth is in the range of about 0.5 to 2.5 GHz. Accordingly, it can be seen that the mmWave has a considerably higher carrier frequency and a considerably larger channel bandwidth than the existing IEEE 802.11 standard. As such, if a high-frequency signal having a wavelength in millimeters (millimeter wave) is used, a high transmission rate of several Gbps can be obtained, and the size of an antenna can be set to be smaller than 1.5 mm. Therefore, a single chip including the antenna can be implemented. In addition, since an attenuation ratio is very high in the air, the interference between apparatuses can be reduced.

In recent years, a technique for transmitting uncompressed audio or video data (hereinafter, referred to as uncompressed A/V data) between wireless apparatuses using the mmWave having a large bandwidth has been studied. Compressed AV data is compressed with a partial loss through processes, such as motion compensation, DCT conversion, quantization, and variable length coding, such that portions of the data insensitive to the sense of sight or the sense of hearing of human beings are eliminated. In contrast, uncompressed A/V data includes digital values (e.g., R, G, and B components) representing pixel components.

Therefore, there is no significant difference between bits included in the compressed AV data, but there is a notable difference between bits included in the uncompressed AV data. For example, as shown in FIG. 2, in case of an 8-bit image, one pixel component is represented by 8 bits. Among the 8 bits, a bit representing the highest order (a bit at the highest level) is the most significant bit (MSB), and a bit representing the lowest order (a bit at the lowest level) is the least significant bit (LSB). That is, in 1-byte data composed of 8 bits, the bits have different significances in restoring a video signal or an audio signal. When an error occurs in a bit having high significance during transmission, it is possible to detect the error easier than when the error occurs in a bit having low significance. Therefore, it is necessary to protect bit data having high significance such that no error occurs in the bit data during wireless transmission, as compared to bit data having low significance. However, a conventional transmission method of correcting errors of all bits to be transmitted at the same code rate has been used in the IEEE 802.11 standard.

FIG. 3 is a diagram illustrating the structure of a PHY protocol data unit (PPDU) of the IEEE 802.11a standard. PPDU 30 includes a preamble, a signal field, and a data field. The preamble is a signal used for synchronizing a PHY layer and estimating a channel, and includes a plurality of short training signals and a plurality of long training signals. The signal field includes a RATE field indicating a transmission rate and a LENGTH field indicating the length of the PPDU. In general, the signal field is coded by one symbol. The data field is composed of PSDU, a tail bit, and a pad bit, and data to be transmitted actually is included in PSDU.

Data recorded on PSDU is composed of codes coded by a convolution encoder. There is no difference in significance between the data, but the data have coded by the same error correction coding process. Therefore, the data have the same error correcting capability. When a receiver detects an error and then requests a transmitter to retransmit data (through ACK), the transmitter retransmits all corresponding data.

The related method is effective in transmitting general data. However, when there is a significant difference between data to be transmitted, a better error correction coding process should be performed on bits having higher significance to reduce the probability that an error occurs in the bits.

The transmitter performs an error correction coding process on data in order to prevent the occurrence of an error. Even when an error occurs in the error correction coded data, the error correction coded data having the error can be restored in a predetermined range in which the error can be corrected. There are various error correction coding processes, and the error correction coding processes have different capabilities to correct errors according to error correction coding algorithms. The performances of the error correction coding algorithms depend on a code rate.

In general, as the code rate becomes higher, the transmission efficiency of data becomes higher, but capability to correct errors is lowered. In contrast, as the code rate becomes lower, the transmission efficiency of data becomes lower, but the capability to correct errors is raised. Therefore, in the case of aimlessly lowering the code rate in order to improve the capability to correct errors, the transmission rate decreases.

When uncompressed AV data is transmitted, if a higher code rate is used for bit data having relatively low significance to increase a transmission rate while a lower code rate is used for bit data having relatively high significance to develop error correction capability, the occurrence of errors sensed by humans can be reduced.

When errors of received data are not completely corrected by an error correction algorithm, a method for requiring a transmission side to perform retransmission can be used. In this case, since the same data needs to be retransmitted, the transmission rate of all data is reduced. If an AV signal is transmitted with a method that only transmits data having a significant affect on human recognition, not all data, it is possible to reduce unnecessary network traffic.

For this reason, it is necessary to design the structure of a data packet allowing a variable process according to the significance of bits constituting uncompressed AV data.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention is to provide a structure of a data packet formatted according to the significance of data in uncompressed AV data.

Another aspect of the present invention is to provide an error correcting method that is more effective in transmission of uncompressed AV data.

Aspects of the present invention are not limited to those mentioned above, and other aspects of the present invention will be understood by those skilled in the art through the following description.

According to an exemplary embodiment of the present invention, there is provided a method of transmitting uncompressed AV data, the method including receiving bits constituting the uncompressed AV data; separating the received bits into a plurality of bit levels according to significance; multiplexing the separated bits according to the bit levels; and transmitting the multiplexed bits.

According to another exemplary embodiment of the present invention, there is provided a method of receiving uncompressed AV data, the method including receiving a wireless signal including the uncompressed AV data; restoring bits having a plurality of bit levels from the received wireless signal; and assembling the bits into a value regarding the same object.

According to another exemplary embodiment of the present invention, there is provided an apparatus for transmitting uncompressed AV data, the apparatus including a bit separating unit which receives bits constituting uncompressed AV data and separates the received bits into a plurality of bit levels according to significance; a multiplexing unit which multiplexes the separated bits according to the bit levels; and a transmitting unit which transmits the multiplexed bits.

According to another exemplary embodiment of the present invention, there is provided an apparatus for receiving uncompressed AV data, the apparatus including a receiving unit receiving a wireless signal including the uncompressed AV data and restoring bits having a plurality of bit levels from the received wireless signal; and a bit assembling unit assembling the bits into a value regarding the same object.

### BRIEF DESCRIPTION OF THE DRAWINGS

The above and other features and advantages of the present invention will become more apparent by describing in detail exemplary embodiments thereof with reference to the attached drawings, in which:

FIG. 1 is a diagram illustrating the comparison between the frequency band of the IEEE 802.11 standard and the frequency band of a millimeter wave;

FIG. 2 is a diagram illustrating one pixel component having a plurality of bit levels;

FIG. 3 is a diagram illustrating the structure of PPDU of the IEEE 802.11a standard;

FIG. 4 is a diagram illustrating the structure of a wireless transmitter according to an exemplary embodiment of the invention;

FIG. 5 is a diagram illustrating the order in which separated bits of sub-pixels are assembled;

FIGS. 6A and 6B are diagrams illustrating a process of multiplexing scanned bits and generating transmission data units (TDUs);

FIG. 7 is a diagram illustrating the structure of a transmission packet according to an exemplary embodiment of the invention;

FIG. 8 is a diagram illustrating the structure of a transmission packet according to another exemplary embodiment of the invention;

FIG. 9 is a block diagram illustrating the structure of a wireless receiver according to an exemplary embodiment of the invention;

FIG. 10 is a flow chart illustrating a method of transmitting uncompressed AV data according to an exemplary embodiment of the invention; and

FIG. 11 is a flow chart illustrating a method of receiving uncompressed AV data according to an exemplary embodiment of the invention.

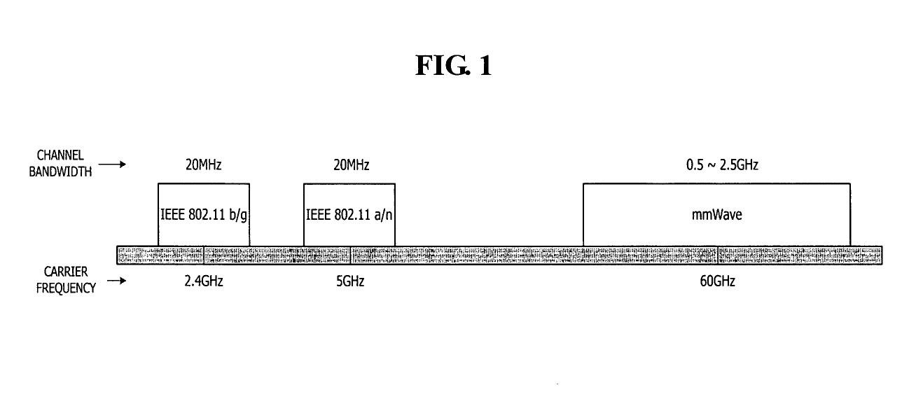

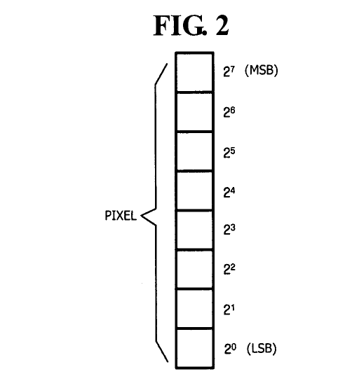

### DETAILED DESCRIPTION OF THE EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

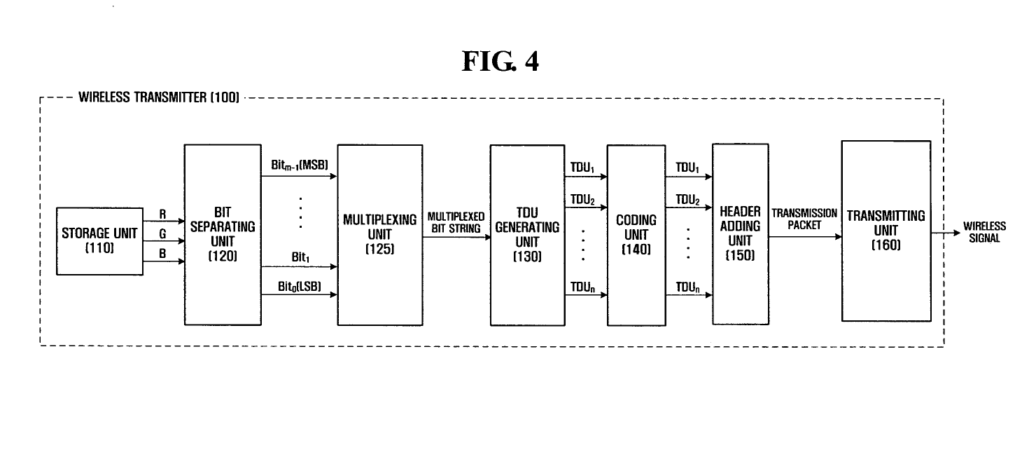

FIG. 4 is a block diagram illustrating the structure of a wireless transmitter 100 for transmitting uncompressed AV data according to an exemplary embodiment of the invention. The wireless transmitter 100 includes a storage unit 110, a bit separating unit 120, a transmission data unit generating unit 130, a coding unit 140, a header adding unit 150, and a transmitting unit 160.

The storage unit 110 stores uncompressed AV data. When the AV data is video data, sub-pixel values of each pixel are stored in the storage unit 110. The sub-pixel values to be stored in the storage unit 110 may vary according to a color space used (for example, an RGB color space and a YCbCr color space). In this exemplary embodiment of the invention, each pixel includes three sub-pixels, that is, R, G, and B sub-pixels, corresponding to the RGB color space. When the video data is a gray-scale image, only one sub-pixel component exists. Therefore, one pixel may be composed of one sub-pixel, or it may be composed of two or four sub-pixels.

The bit separating unit 120 separates the sub-pixel values (binary values) supplied from the storage unit 110 from a high-order bit to a low-order bit. For example, in case of an 8-bit video signal, the video signal is composed of orders from 2⁰ to 2⁷, and thus it may be separated into 8 bits. In FIG. 4, “m” indicates the number of bits of a pixel, and “Bitₘ₋₁” indicates the bit of an order m−1. The bit separating process is independently performed on each sub-pixel.

In order to classify the separated bits according to significance, the multiplexer 125 multiplexes the separated bits according to their levels (orders). Then, the transmission data unit generating unit (hereinafter, referred to as a TDU generating unit) 130 generates transmission data units (TDUs) having a layer structure from the multiplexed bits.

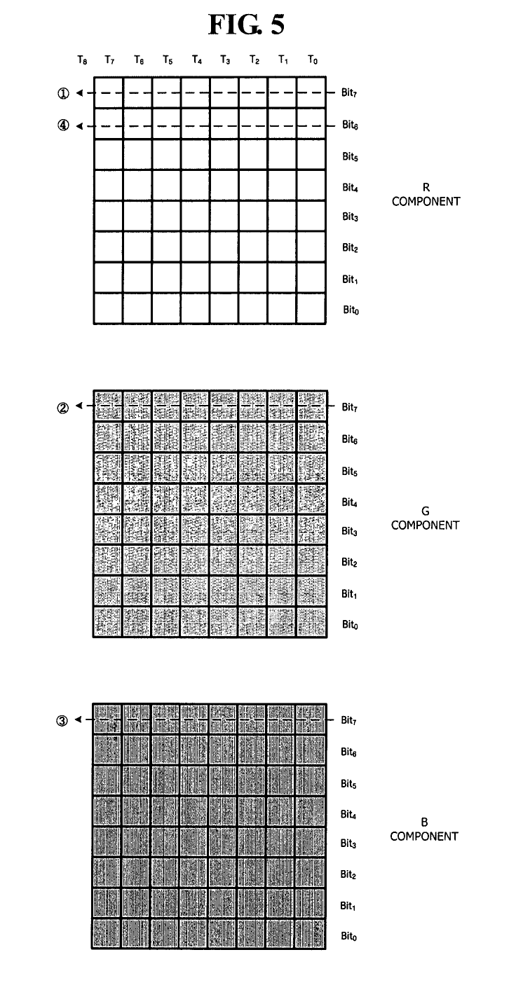

FIG. 5 is a diagram illustrating a process of multiplexing the separated bits of the sub-pixels. In FIG. 5, T₀ to T₇ indicate the order of pixels. That is, scanning is sequentially performed on pixels in the left direction from T₀.

The sub-pixel values (binary values) input for the sequential scanning are sequentially stored in a predetermined buffer (not shown). The sub-pixel values may be sequentially stored in a memory in the order in which data is input, and desired bits may be read by scanning in the order of addresses supplied from a data address generator (not shown).

The scanning process is sequentially performed on the bits in the order from the most significant bit to the least significant bit. However, in the scanning process, since one pixel is composed of three components, that is, R, G, and B components, scanning is sequentially performed on the most significant bit of the R component \textcircled{1}, the most significant bit of the G component \textcircled{2}, and the most significant bit of the B component \textcircled{3}. Then, scanning is performed on the next high-level bit Bit₆ of the R component \textcircled{4}. This scanning process is repeated until the least significant bit of the B component is scanned.

In order to reduce a play delay that will occur in the receiver side, the method of alternately scanning bits having the same order (level) of the sub-pixel components is used rather than a method of completely scanning all bits of one sub-pixel component and then scanning the next sub-pixel component. In this exemplary embodiment, scanning is sequentially performed on R, G, and B sub-pixels, but the invention is not limited thereto. For example, the scanning order may vary according to user's selection.

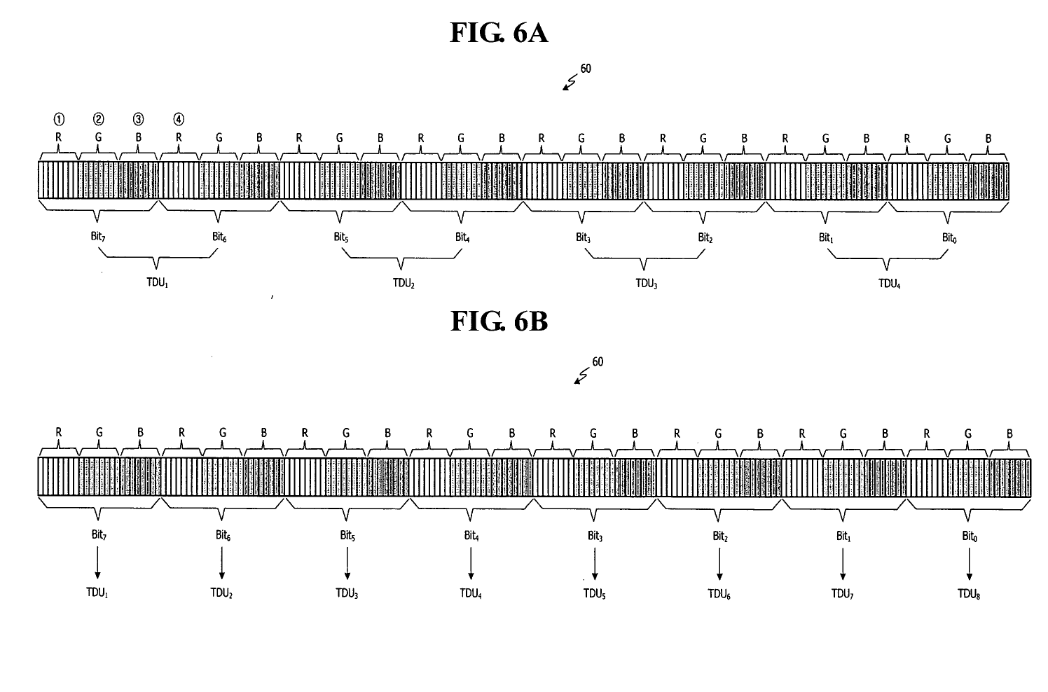

FIG. 6 is a diagram illustrating TDUs and bits multiplexed by the scanning shown in FIG. 5.

A multiplexed bit stream 60 is arranged in the order from the most significant bit to the least significant bit, and bits in the same order (bits at the same level) are arranged in the order of R, G, and B components. However, bits belonging to one level directly are not necessarily a TDU. A TDU is a process unit in determining of a modulation method, determining of an error correction method, retransmission, etc. As illustrated in FIG. 6, in a case of an 8-bit image having 8 levels, the number of TDUs may be smaller than the number of levels (for example, 8, 4, or 2). That is, when the size of the TDU is k levels, the number of TDUs (“n” in FIG. 4) becomes m/k (m is the number of levels).

FIG. 6A illustrates an example in which the size of the TDU is 2. In FIG. 6A, a TDU₁ is a data unit having the highest priority and is composed of the most significant bit Bit₇ and a bit Bit₆ at the next level, and a TDU₄ is a data unit having the lowest priority and is composed of the least significant bit Bit₀ and a bit Bit₁ at the next level.

In addition to the bit data, a tail bit and a pad bit may be added to each TDU. The tail bit is used for initializing a convolution coder, and the pad bit is a dummy bit added for making data bits be an integral multiple of coded bits of a symbol.

The size of the TDU may be 1. In this case, as illustrated in FIG. 6B, each bit level corresponds to one TDU. As described above, the number of bit levels included in one TDU may be changed according to user's intention to use the wireless transmitter 100. Since the setting of a code rate or the setting of a retransmission method is differently performed for every TDU, as the number of TDUs increases (as the number of bit levels included in the TDU decreases), the setting can be more minutely performed. However, in order to reduce complexity in a data processing procedure performed by the wireless transmitter 100, the number of TDUs can be reduced.

The individual TDUs generated by the TDU generating unit 130 are supplied to the coding unit 140. The coding unit 140 determines a code rate for each TDU and performs error correction coding on the corresponding TDU at the determined code rate. Examples of the error correction coding include block coding and convolution coding. The block coding (for example, Reed-Solomon coding) performs coding and decoding on data in predetermined block units, and the convolution coding performs coding by comparing previous data and current data using a memory having a predetermined length.

The error correction coding is generally a process of converting k-bit input data into an m-bit codeword. In this case, the code rate is “k/m”. As the code rate decreases, the input data is converted into a codeword having a larger number of bits. Therefore, the possibility of the error being corrected increases.

For this reason, the code rate is determined such that a lower code rate is applied to a TDU having a higher priority. For example, in a case where the number of TDUs supplied from the TDU generating unit 130 is 2 (n=2), it is possible that a code rate of 4/7 is applied to a TDU having a higher priority and a code rate of 4/5 is applied to a TDU having a lower priority. In general, a forward error correction (FEC) technique cannot perfectly perform error correction when an error rate is larger than a predetermined value. However, even in the case where the error rate is larger than the predetermined value, when a low code rate is applied to a TDU transmitted, since the coding late is low, the possibility that the error correction is perfectly performed is strong. That is, it is possible to transmit a TDU having a high priority more stably.

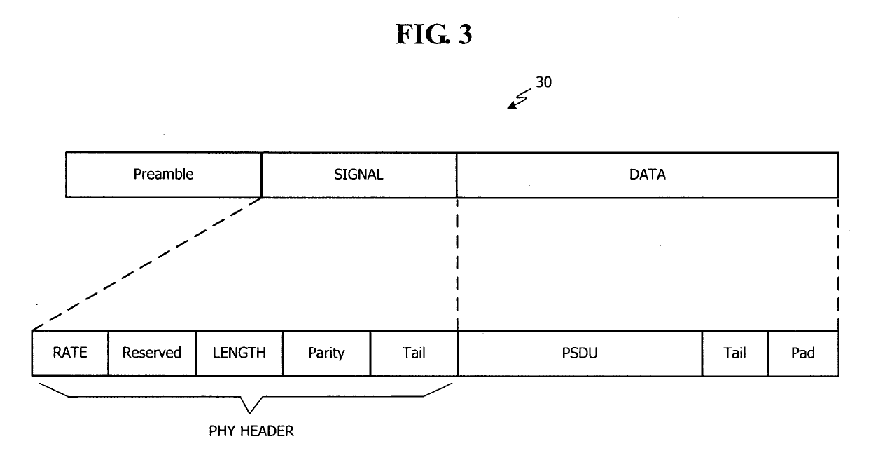

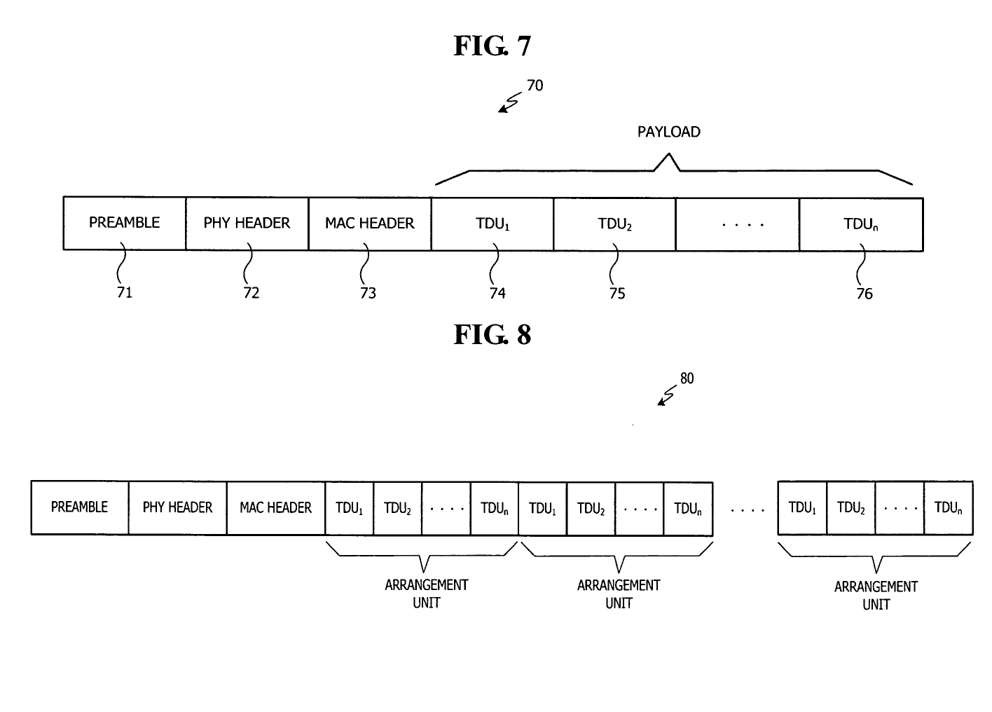

As illustrated in FIG. 7, the header adding unit 150 adds a MAC header 73, a PHY header 72, and a preamble 71 to the payload composed of the plurality of TDUs 74, 75 and 76 on which the error correction coding has been performed by the coding unit 140. The preamble 71 is a signal for synchronization of a physical (PHY) layer and channel estimation and includes a plurality of short and long training signals. In general, the short training signal is used for signal detection, AGC Automatic Gain Control (AGC), minute time synchronization, integral-multiple-frequency error estimation, etc. and the long training signal is used for channel estimation, decimal-multiple-frequency error estimation, etc. The PHY header 72 may include a RATE field, a LENGTH field, and so on, as illustrated in FIG. 3. When the transmission rate varies for every TDU, the RATE field may have the transmission rates of the plurality of TDUs recoded therein or an index value of a predetermined table in which the transmission rates of the plurality of TDUs are defined. The MAC header 73 is generally used for media access control, and a MAC address, an ACK policy, fragment information, etc. of a transmitter and a receiver are recorded in the MAC header 73.

The transmitting unit 160 transmits the data coded at the determined code rate, that is, codes and transmits a transmission packet 70 as illustrated in FIG. 7. Specific examples of a modulation method include QPSK, 16QAM, 32QAM, and 64QAM, and in one modulation method, different code rates can be applied for every TDU. More specifically, the transmitting unit 160 performs digital signal processes, such as scrambling and channel coding, performs modulation, pilot signal addition, addition of other signals including a protection section signal, A/D signal conversion, amplification, etc., and transmits a wireless signal through an antenna.

FIG. 8 is a diagram illustrating the structure of a transmission packet 80 according to another exemplary embodiment of the invention. In FIGS. 5 and 6, bits having the same level are grouped to one group (i.e., within a range capable of being contained in the transmission packet) and are included in one TDU. When all bits having the same level form a group, a little delay may occur in the receiver. Therefore, it is considered to classify all bits having the same level into a predetermined number of groups (for example, 8 groups). In this case, scanning is performed on the bits from the most significant bit of the R component to the least significant bit of the B component in a predetermined unit, and then scanning is repeatedly performed on a pixel next the predetermined unit (e.g., when the predetermined unit is 8, T₈).

Therefore, groups of bits having the same level are repeatedly connected to each other, as shown in FIG. 6. For example, after Bit₀, Bit₇ follows. Accordingly, as illustrated in FIG. 8, in the transmission packet 80, the TDUs are repeatedly arranged in arrangement units.

Even in the transmission packet 80 of FIG. 8, the same code rate is applied to TDUs in the same group (i.e., TDUs denoted by the same suffix), and the transmitting unit 160 transmits the transmission packet 80 at a variable code rate on the basis of the applied code rate.

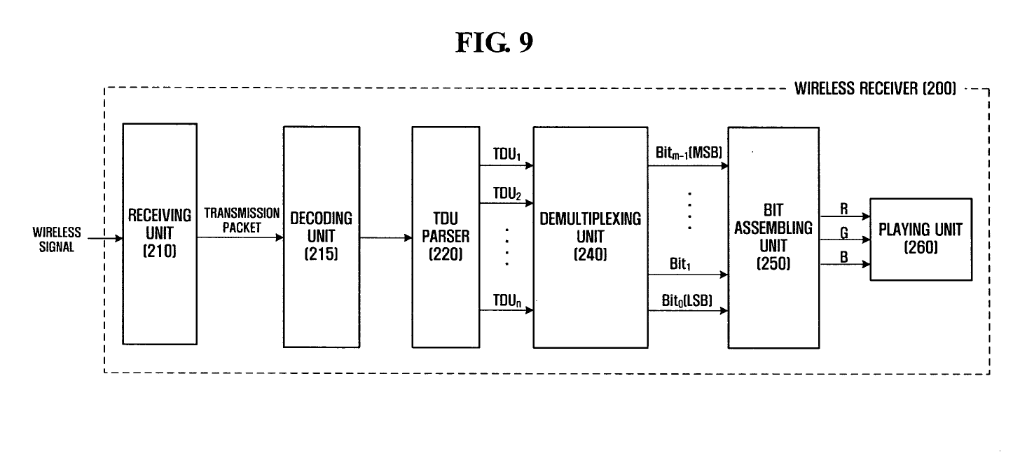

FIG. 9 is a block diagram illustrating the structure of a wireless receiver 200 according to an exemplary embodiment of the invention. The wireless receiver 200 includes a receiving unit 210, a decoding unit 215, a parser 220, a header reading unit 230, a demultiplexing unit 240, a bit assembling unit 250, and a storage unit 260.

The receiving unit 210 demodulates a received wireless signal to restore a transmission packet. At this time, the receiving unit 210 uses a demodulation method corresponding to the modulation method used by the transmitting unit 160.

The decoding unit 215 performs error correction decoding on the TDUs, on which the error correction coding has been performed, of the restored packet, on the basis of the code rate applied to each TDU. The code rate may be a promise between the wireless transmitter 100 and the wireless receiver 200 or may be recoded in some fields of the PHY header of the transmission packet and transmitted to the wireless receiver 200. For example, when a wireless signal including the transmission packet as illustrated in FIG. 7, TDU₁, TDU₂, and TDUₙ subjected to error correction coding may be decoded at different code rates.

The TDU parser 220 reads the payload of the transmission packet subjected to error correction coding, breaks the payloads into the individual TDUs, and supplies the TDUs to the demultiplexing unit 240.

The demultiplexing unit 240 demultiplexes the supplied TDUs to separate the data into bits having a plurality of levels. The bits are sequentially separated from the most significant bit Bitₘ₋₁ to the least significant bit Bit₀. When a pixel of video data is composed of a plurality of sub-pixel components, the separated bits may also exist for every sub-pixel component.

The bit assembling unit 250 assembles the separated bits having a plurality of levels (from the highest level to the lowest level) to restore each sub-pixel component. The restoring process is a process of restoring sub-pixel components as shown in FIG. 5 from the TDUs as shown in FIG. 6 and uses the scanning order used in FIG. 5. The sub-pixel components (e.g., R, G, and B components) restored by the bit assembling unit 250 are supplied to the playing unit 260.

The playing unit 260 collects sub-pixel components, that is, pixel data in a temporary buffer until one video frame is completed. When one video frame is completed, the playing unit 260 displays the video frame on a display device (not shown), such as a cathode ray tube (CRT), a liquid crystal display (LCD), or a plasma display panel (PDP), in synchronization with a play synchronization signal.

In this exemplary embodiment of the invention, a case in which uncompressed video data is used as the uncompressed AV data is exemplified, but the invention is not limited thereto. For example, it will be understood by those skilled in the art that uncompressed audio data, such as a wave file, can be used as the uncompressed AV data.

The components shown in FIGS. 4 and 9 are realized by software executed in a predetermined area of a memory, such as a task, a class, a sub-routine, a process, an object, an execution thread, or a program, or hardware, such as field-programmable gate array (FPGA) or application-specific integrated circuit (ASIC), or they may be realized by combinations of software and hardware. The components may be stored in a computer readable storage medium, or the components may be dispersed in a plurality of computers.

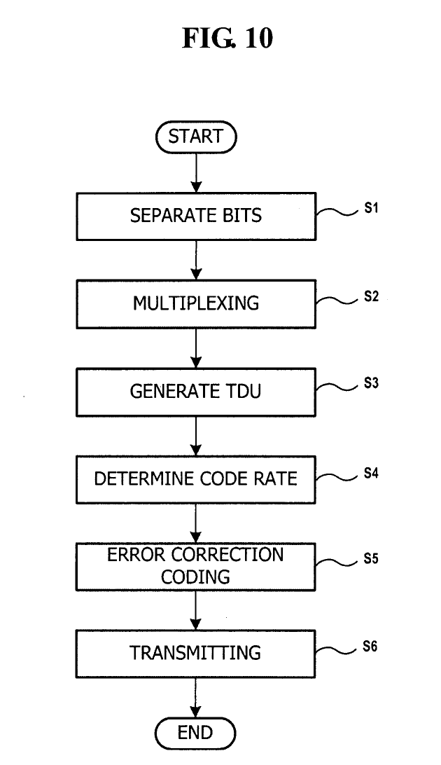

FIG. 10 is a flow chart illustrating a method of transmitting uncompressed AV data according to an exemplary embodiment of the invention.

First, the bit separating unit 120 receives bits constituting uncompressed AV data and separates the received bits into a plurality of bit levels according to the significance (S1). The significance may be determined according to the orders of the bits.

The multiplexing unit 125 groups the separated pixel bits according to the bit levels and multiplexes the grouped bits (S2). At this time, the multiplexing unit 125 may make a relatively higher bit level be positioned in front of a relatively lower bit level or make a relatively lower bit level be positioned in front of a relatively higher bit level.

The TDU generating unit 130 divides the multiplexed pixel bits into a plurality of transmission data units (S3). At this time, the TDU generating unit 130 may add a tail bit and a pad bit to the divided transmission data units.

The coding unit 140 determines the code rate for every transmission data unit (S4), and performs error correction coding according to the determined code rate (S5). At this time, the coding unit 140 applies, to a first transmission data unit including a bit having a relatively higher bit level among the divided transmission data units, a code rate lower than or equal to a code rate applied to a second transmission data unit including a bit having a relatively lower bit level.

Then, the transmitting unit 160 transmits the transmission data unit subjected to error correction coding in a wireless signal form (S6). It can be considered that the AV data is video data, and the bits constituting the AV data are values representing sub-pixels included in pixels constituting the video data.

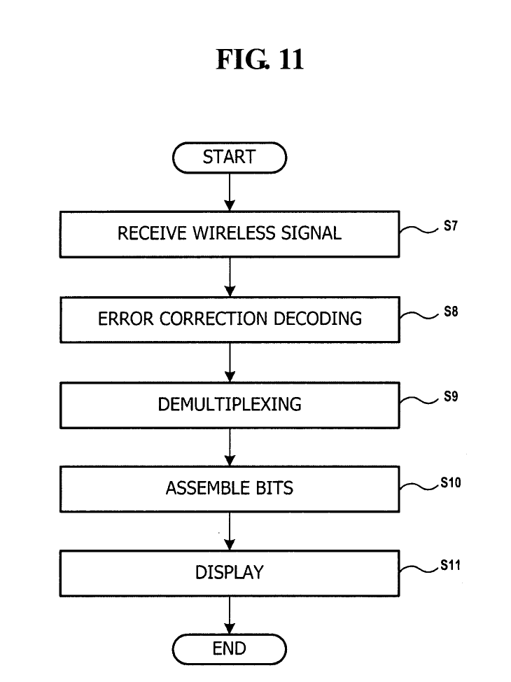

FIG. 11 is a flow chart representing a method of receiving uncompressed AV data according to an exemplary embodiment of the invention.

The receiving unit 210 receives a wireless signal including uncompressed AV data and restores a transmission packet (S7). At this time, the receiving unit 210 reads code rates applied according to the significance of bit levels. The code rates may be included in a PHY header of the wireless signal. Then, the decoding unit 215 performs error correction decoding on the transmission data units subjected to error correction coding that is included in the transmission packet according to the code rates (e.g., the read code rates) applied to each transmission data units (S8).

The demultiplexing unit 240 demultiplexes the bits included in the transmission data unit subjected to the error correction decoding and outputs bits having a corresponding bit level (S9). Then, the bit assembling unit 250 assembles the output bits into a value regarding the same object (S10). When the AV data is video data, the bits constituting the AV data are values representing sub-pixels included in pixels constituting the video data and the same object means the same pixel.

Finally, when the sub-pixel components are gathered to complete one video frame, the playing unit 260 displays the video frame in synchronization with a play sync signal (S11).

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

According to this invention, the transmission method for transmitting uncompressed AV data can be changed according to the significance of data, and it is possible to more effectively perform error correction as compared to a case when errors occur on the receiving side.

What is claimed is:

1. A method of transmitting uncompressed AV data, the method comprising:
receiving bits constituting the uncompressed AV data;
separating the received bits into a plurality of bit levels according to significance;
multiplexing the separated bits according to the bit levels; and
transmitting the multiplexed bits.

2. The method of claim 1, wherein the transmitting of the multiplexed bits comprises:
classifying the multiplexed bits into a plurality of transmission data units;
determining a code rate for each of the transmission data units; and
transmitting each of the transmission data units at the determined code rate.

3. The method of claim 2, wherein the determining of the code rate comprises applying a code rate which is lower than or equal to a code rate applied to a second transmission data unit comprising bits having a relatively lower bit level to a first transmission data unit including bits having a relatively higher bit level among the transmission data units.

4. The method of claim 1, wherein the multiplexing of the separated bits comprises performing multiplexing such that a relatively higher bit level is positioned in front of a relatively lower bit level.

5. The method of claim 1, wherein, when the received bits each represent one component of a plurality of sub-pixels, the multiplexing of the separated bits comprises performing multiplexing such that the received bits are divided into the sub-pixels at a same bit level and arranged.

6. The method of claim 1, wherein the multiplexing of the separated bits comprises performing multiplexing such that a relatively lower bit level is positioned in front of a relatively higher bit level.

7. The method of claim 1, wherein the uncompressed AV data is video data and bits constituting the uncompressed AV data are values representing sub-pixels included in pixels constituting the video data.

8. The method of claim 1, wherein the significance is determined according to an order of each bit.

9. A method of receiving uncompressed AV data, the method comprising:
receiving a wireless signal including the uncompressed AV data;
restoring bits having a plurality of bit levels from the received wireless signal; and
assembling the restored bits into a value regarding a same object.

10. The method of claim 9, wherein the receiving of the wireless signal comprises:
reading code rates applied according to significance of bit levels; and
performing error correction coding on the wireless signal at the code rates.

11. The method of claim 10, wherein the code rate is included in a physical (PHY) header of the wireless signal.

12. The method of claim 9, wherein bits having a relatively higher bit level of the bit levels are positioned in the front part of the AV data.

13. The method of claim 9, wherein bits having a relatively lower bit level of the bit levels are positioned in the front part of the AV data.

14. The method of claim 9, wherein the AV data is video data and bits constituting the AV data are values representing sub-pixels included in pixels constituting the video data.

15. The method of claim 14, wherein the same object is a same pixel.

16. An apparatus for transmitting uncompressed AV data, the apparatus comprising:
a bit separating unit which receives bits constituting the uncompressed AV data and separates the received bits into a plurality of bit levels according to significance;
a multiplexing unit which multiplexes the separated bits according to the bit levels; and
a transmitting unit which transmits the multiplexed bits.

17. The apparatus of claim 16, further comprising a TDU generating unit which divides the multiplexed bits into a plurality of transmission data units, wherein the transmitting unit determines a code rate for each divided transmission data unit and transmits the corresponding transmission data unit according to the determined code rate.

18. The apparatus of claim 17, wherein the transmitting unit applies a code rate which is lower than or equal to a code rate applied to a second transmission data unit including a bit having a relatively lower bit level to a first transmission data unit including a bit having a relatively higher bit level among the divided transmission data units.

19. The apparatus of claim 16, wherein the multiplexing unit multiplexes such that a relatively higher bit level is positioned in front of a relatively lower bit level.

20. The apparatus of claim 16, wherein the multiplexing unit performs multiplexes such that a relatively lower bit level is positioned in front of a relatively higher bit level.

21. The apparatus of claim 16, wherein the AV data is video data and bits constituting the AV data are values representing sub-pixels included in pixels constituting the video data.

22. The apparatus of claim 16, wherein the significance is determined according to an order of each bit.

23. An apparatus for receiving uncompressed AV data, the apparatus comprising:
a receiving unit which receives a wireless signal comprising the uncompressed AV data and restores bits having a plurality of bit levels from the received wireless signal; and
a bit assembling unit which assembles the bits into a value regarding a same object.

24. The apparatus of claim 23, wherein the receiving unit reads a code rate applied according to significance of bit levels and performs error correction coding on the wireless signal on the basis of the code rate.

25. The apparatus of claim 24, wherein the code rate is included in a physical (PHY) header of the wireless signal.

26. The apparatus of claim 23, wherein bits having a relatively higher bit level of the bit levels are positioned in the front part of the AV data.

27. The apparatus of claim 23, wherein bits having a relatively lower bit level of the bit levels are positioned in the front part of the AV data.

28. The apparatus of claim 23, wherein the AV data is video data and bits constituting the AV data are values representing sub-pixels included in pixels constituting the video data.

29. The apparatus of claim 23, wherein the same object is a same pixel.

30. A transmission packet structure for transmitting uncompressed AV data, the structure comprising:
a header field having additional data regarding the uncompressed AV data recorded therein; and
a plurality of transmission data unit fields composed of at least one bit level into which bits of the uncompressed AV data are divided according to a significance of each bit.

31. The transmission packet structure of claim 30, wherein different code rates are applied to the transmission data units.
